(19) United States
(12) Patent Application Publication
(10) Pub. No.: US 2024/0242071 A1
(43) Pub. Date: Jul. 18, 2024

(54) ACCELERATOR CIRCUIT, SEMICONDUCTOR DEVICE, AND METHOD FOR ACCELERATING CONVOLUTION CALCULATION IN CONVOLUTIONAL NEURAL NETWORK

(71) Applicant: TAIWAN SEMICONDUCTOR MANUFACTURING COMPANY LTD., HSINCHU (TW)

(72) Inventors: XIAOCHEN PENG, SAN JOSE, CA (US); MURAT KEREM AKARVARDAR, HSINCHU CITY (TW); XIAOYU SUN, SAN JOSE, CA (US)

(21) Appl. No.: 18/156,369

(22) Filed: Jan. 18, 2023

(51) Int. Cl. G06N 3/08

(52) U.S. Cl. CPC G06N 3/08

(57) ABSTRACT

The present disclosure provides an accelerator circuit, a semiconductor device, and a method for accelerating convolution in a convolutional neural network. The accelerator circuit includes a plurality of sub processing-element (PE) arrays, and each of the plurality of sub PE arrays includes a plurality of processing elements. The processing elements in each of the plurality of sub PE arrays implement a standard convolutional layer during a first configuration applied to the accelerator circuit, and implement a depth-wise convolutional layer during a second configuration applied to the accelerator circuit.

### BACKGROUND

The present disclosure relates to a machine-learning accelerators, and, in particular, to an accelerator circuit, a semiconductor device, and a method for accelerating convolution calculation in a convolutional neural network (CNN).

Convolutional neural networks have been widely deployed in deep learning applications, such as computer vision applications. However, the scale of workloads of the CNNs has grown larger and larger due to high demands for computation capabilities, and the data transfer between the hardware accelerators and the memory has become the main bottleneck. Moreover, the same hardware accelerator of an existing CNN may be not suitable for both the standard convolution and depth-wise convolution. It may lead to low utilization of processing elements in the hardware accelerators.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a diagram showing operations of a standard convolution in a convolutional layer in accordance with an embodiment of the disclosure.

FIG. 2 is a diagram showing operations of a standard convolution in a convolutional layer in accordance with another embodiment of the disclosure.

FIG. 3 shows the architecture of the accelerator circuit of the convolutional layer in accordance with the embodiment of FIG. 2.

FIG. 4 shows the architecture of a sub PE array in the accelerator circuit of the convolutional layer in accordance with the embodiment of FIG. 3.

FIG. 5 is a diagram showing the weight-stationary data flow in the accelerator circuit of the convolutional layer in accordance with the embodiment of FIG. 3.

FIG. 6 is a diagram showing operations of a depth-wise convolution in a convolutional layer in accordance with an embodiment of the disclosure.

FIG. 7 is a diagram showing the input-stationary data flow in the accelerator circuit of the convolutional layer in accordance with the embodiment of FIG. 6.

FIG. 8 is a diagram of a perspective view of the accelerator circuit of the convolutional layer in accordance with the embodiment of FIG. 3.

FIG. 9 shows the architecture of the accelerator circuit of the convolutional layer in accordance with the embodiment of FIG. 1.

FIG. 10 is a diagram of a method for accelerating convolution calculation in a convolutional neural network in accordance with an embodiment of the disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

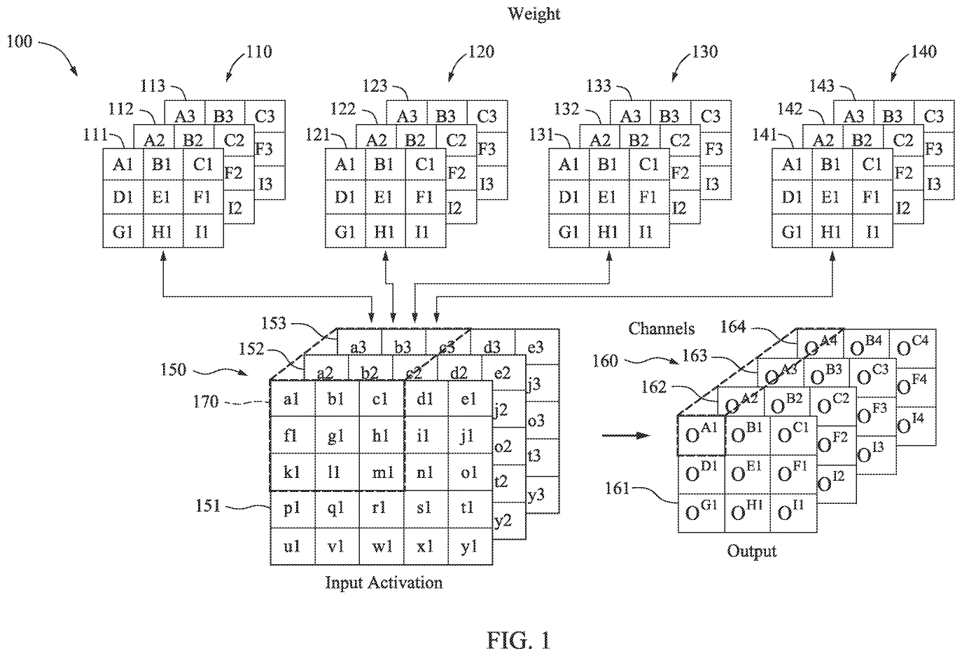

FIG. 1 is a diagram showing operations of a standard convolution in a convolutional layer in accordance with an embodiment of the disclosure.

In an embodiment, in the convolutional layer 100, an input activation cube 150 is applied to every weight cube (e.g., weight cubes 110, 120, 130, and 140) so as to perform multiply-accumulate (MAC) operations to generate an output cube 160. For example, the weight cubes 110, 120, 130, and 140 may be regarded as filters, and the input activation cube 150 may be regarded as activation data. In addition, the number of layers in the weight cubes 110, 120, 130, and 140, and the input activation cube 150 may refer to the number of channels of the activation data.

In this embodiment, the filter is a 3×3 filter, which slides over the activation data by a specific stride (e.g., 1) in a raster scan order (e.g., from top to bottom, and from left to right). For example, in the beginning of the convolutional operation, the weight elements A1 to I1 in array 111 are respectively multiplied with elements a1, b1, c1, f1, g1, h1, k1, l1, and m1 of the input activation data in window 170 of array 151, and the multiplication products are accumulated to generate a first accumulated value. Similarly, the weight elements A2 to I2 in array 112 are respectively multiplied with elements a2, b2, c2, f2, g2, h2, k2, l2, and m2 of the input activation data in window 170 of array 152, and the multiplication products are accumulated to generate a second accumulated value. The weight elements A3 to I3 in array 113 are respectively multiplied with elements a3, b3, c3, f3, g3, h3, k3, l3, and m3 of the input activation data in window 170 of array 153, and the multiplication products are accumulated to generate a third accumulated value. The first accumulated value, the second accumulated value, and the third accumulated value are summed to generate the element O^{A1} in array 161 of the output cube 160.

Then, the filter slides right by the specific stride (e.g., 1). That is, window 170 is shifted right by one pixel. Accordingly, the weight elements (e.g., A1 to I1, A2 to I2, and A3 to I3) in arrays 111, 112, and 113 are multiplied with respective elements b1, c1, d1, g1, h1, i1, l1, m1, and n1 to generate a fourth accumulated value, a fifth accumulated value, and a sixth accumulated value. The fourth accumulated value, the fifth accumulated value, and the sixth accumulated value are summed to generate the element O^{B1} in array 161 of the output cube 160. Accordingly, other elements O^{C1} to O^{I1} in array 161 can be calculated in a similar fashion.

It should be noted that each of the weight cubes 110 to 140 can be regarded as the weight cube in an independent channel, and thus the convolutional calculations of each of the weight cubes 120, 130, and 140 with the input activation cube 150 can be performed independently in a fashion similar to that described so as to obtain elements in arrays 162, 163, and 164.

It should also be noted that the number of layers in the weight cubes 110 to 140 and input activation cube 150 shown in FIG. 1 is for purposes of description, and it can be changed according to actual needs. The number of layers in the output cube 160 depends on the volume convolutional operations of the weight cubes 110 to 140 and the input activation cube 150. Therefore, for a standard convolution, each filter (e.g., weight) is convolved with all of the input's channels to produce a single channel filter output. These outputs are concatenated to obtain the channel output of the standard convolution.

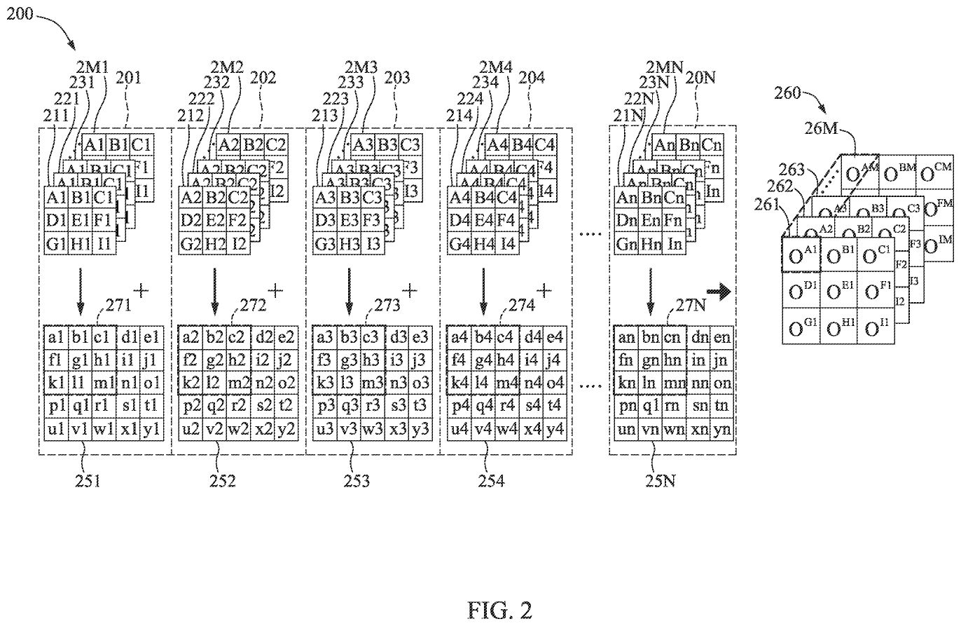

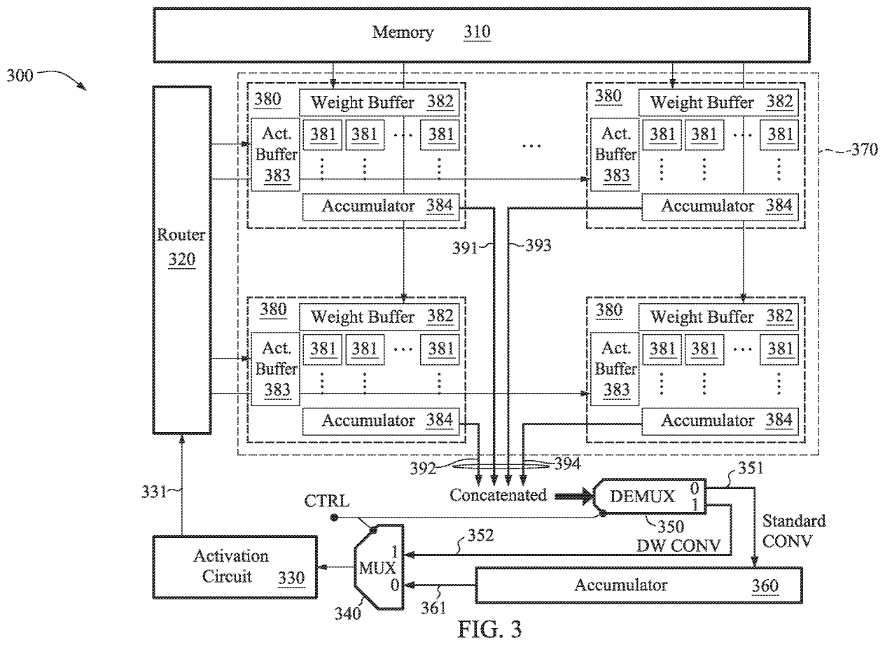

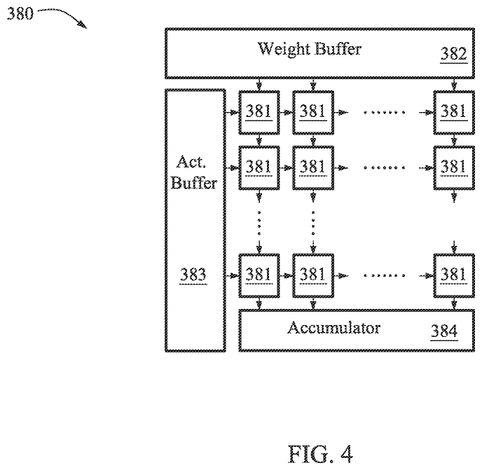

FIG. 2 is a diagram showing operations of a standard convolution in a convolutional layer in accordance with another embodiment of the disclosure. FIG. 3 shows the architecture of the hardware circuit of the convolutional layer in accordance with the embodiment of FIG. 2. FIG. 4 shows the architecture of a sub PE array in the hardware circuit of the convolutional layer in accordance with the embodiment of FIG. 3. Please refer to FIGS. 1 to 4.

Referring to FIG. 2, in some embodiments, the convolutional layer 100 shown in FIG. 1 can be modified to the convolutional layer 200 shown in FIG. 2. For example, convolutional operations in the convolutional layer 200 may be based on the reshaped weight and separated input activation. Specifically, arrays 211 to 21N in FIG. 2, which are different layers in the same weight cube, may be similar to arrays 111 to 113 in the weight cube 110 in FIG. 1. Arrays 221 to 22N in FIG. 2, which are different layers in another weight cube, may be similar to arrays 121 to 123 in weight cube 120 in FIG. 1, and so on.

In block 201, each of arrays 211 to 2N1 may be the topmost layer or first layer in the respective weight cube, and the elements A1 to I1 in each of arrays 211 to 2N1 are respectively multiplied with the elements a1, b1, c1, f1, g1, h1, k1, l1, and m1 in window 271 in array 251. Similarly, the elements A2 to I2 in each of arrays 212 to 2N2 are respectively multiplied with the elements a2, b2, c2, f2, g2, h2, k2, l2, and m2 in window 272 in array 252, and so on.

The multiplication products for arrays 211 to 21N are accumulated to generate the element O^{A1} in array 261 of the output cube 260. The elements O^{A2} to O^{AM} in arrays 262 to 26M in the output cube 260 can be calculated in a similar manner. Afterwards, the windows 271 to 27N may be shifted by a specific stride (e.g., 1), and similar MAC operations are performed to generate the elements O^{B1} to O^{BM} in array 261 of the output cube 260. Likewise, after the windows 271 to 27N respectively move throughout the arrays 251 to 25N in the raster scan order, all elements in arrays 261 to 26M of the output cube 260 can be calculated.

It should be noted that the result of the standard convolution using the convolutional layer 200 in FIG. 2 is the same as that using the convolutional layer 100 in FIG. 1. In addition, a specific pair of weight and activation data will not require the data from other pairs in the flow of the standard convolution in FIG. 2, and thus the dedicated hardware circuit for the convolutional layer 200 can have local computation and data storage for independent computation.

Attention now is directed to FIG. 3, which shows the architecture of the hardware circuit of the convolutional layer 200 in FIG. 2. In an embodiment, the accelerator circuit 300 may include a memory 310, a router 320, an activation circuit 330, a multiplexer (MUX) 340, a demultiplexer (DEMUX) 350, an accumulator 360, and a processing-element (PE) array 370. The PE array 370 may include a plurality of sub PE arrays 380.

The memory 310 is configured to store the weights for the convolution operations (i.e., including standard convolution and depth-wise convolution). The router 320 may be configured to distribute the activation data from the activation circuit 330 to the respective activation buffer 383 in each sub PE array 380. The activation circuit 330 may be a circuit with collective functions including activation, pooling, batch normalization (BN), and quantization, and thus the activation circuit 330 can be regarded as an activation/pool/BN/quantizer unit.

Specifically, the activation function of the activation circuit 330 may be enabled while the functions of pooling, batch normalization, and quantization of the activation circuit 330 are selectively enabled depending on the operating requirements of the convolutional neural network. For example, in some cases, the functions of pooling, batch normalization, and quantization may be disabled. In some other cases, the functions of pooling, batch normalization, and quantization may be enabled. In yet some other cases, part of the functions of pooling, batch normalization, and quantization may be enabled.

As shown in FIG. 3 and FIG. 4, each of the sub PE arrays 380 may include a plurality of processing elements 381, a weight buffer 382, an activation buffer 383, and an accumulator 384. The processing elements 381 in each sub PE array are arranged into a two-dimensional systolic array, and each of the processing elements 381 may perform a multiply-accumulate (MAC) operation. In addition, the number of processing elements 381 in each row and each column of each sub PE array 380 may depend on the width of the input activation data and weights. Each of the memory 310, the weight buffer 382, and the activation buffer 383 may be implemented by a volatile memory or a non-volatile memory. The volatile memory may be a static random access memory (SRAM) or a dynamic random access memory (DRAM), but the disclosure is not limited thereto.

For example, referring to FIG. 4, the data-processing flow of the processing elements 381 may be weight stationary or activation stationary (input stationary). Given that the weight-stationary data-processing flow is used, upon start of the convolutional operation, the weights are loaded from the memory 310 to the respective weight buffer 382 in each sub PE array 380, and the activations are loaded from the router 320 to the respective activation buffer 383 in each sub PE array 380. For example, the weights in each array in blocks 201 to 20N are unrolled and preloaded from the respective weight buffer 382 to the processing elements 381 in each sub PE array 380.

Then, for each sub PE array 380, the weight for each processing element 381 is loaded from the weight buffer 382 to the corresponding processing element 381. In addition, for each sub PE array 380, the activation data for the convolutional operation are sequentially loaded from the activation buffer 383 to the left-most column of processing elements 381 in parallel, and the activation data is forwarded to the processing elements 381 in the next column every one clock cycle.

Accordingly, in each sub PE array 380, each processing element 381 can perform a MAC operation by multiplying the input activation data with the preloaded weight to generate a multiplication product, and adding the multiplication product to the incoming partial sum from the processing element 381 in the neighboring upper row (i.e., previous row) to generate an output partial sum. In other words, the output partial sums of the processing elements 381 in a given row, which is not the last row, are transmitted to the processing elements 381 in the next row. When the given row is the last row, the output partial sums calculated by the processing elements 381 in the given row are sent to the accumulator 384 (i.e., a local accumulator in each sub PE array 380), and the accumulator 384 may accumulate output partial sums from the processing elements 381 in the last row (i.e., bottom row) to generate a partial sum (e.g., partial sums 391 to 394) for the sub PE array 380. For purposes of description, there are four partial sums (e.g., partial sums 391 to 394) of the sub PE arrays 380 labeled on FIG. 3.

The partials sum generated by each of sub PE arrays 380 may be concatenated into a data bus that is input to the demultiplexer 350. The multiplexer 340 and the demultiplexer 350 are controlled by a control signal CTRL. When the control signal CTRL is in a low logic state, the accelerator circuit 300 may be used to perform the standard convolution (i.e., standard CONV). In other words, the processing elements 381 in each sub PE array 380 implement a standard convolutional layer during a first configuration (i.e., the control signal CTRL is in the low logic state).

When the control signal CTRL is in a high logic state, the accelerator circuit 300 may be used to perform the depth-wise convolution (i.e., DW CONV). In other words, the processing elements 381 in each sub PE arrays 380 implement a depth-wise convolutional layer during a second configuration (i.e., the control signal CTRL is in the high logic state). It should be noted that the concatenated partial sums 351 and 352 output by the demultiplexer 350 may be substantially the same, but they are for different convolution modes. For example, the concatenated partial sum 351 is for the standard convolution, and the concatenated partial sum 352 is for the depth-wise convolution.

In response to the control signal CTRL being in the low logic state, the demultiplexer 350 may output the concatenated partial sum 351 to the accumulator 360 so as to perform element-wise accumulation for the standard convolution. For example, the concatenated partial sum 351 includes the partial sums generated by each of the sub PE arrays 380, and each partial sum of the concatenated partial sum 351 can be regarded as an input element of the accumulator 360 (i.e., a global accumulator for the accelerator circuit 300). Thus, the elements in the concatenated partial sum 351 (i.e., the partial sums generated by the sub PE arrays 380) may be accumulated by the accumulator 360 to generate an accumulation result 361, which is an input of the multiplexer 340. At this time, since the control signal CTRL is in the low logic state, the multiplexer 340 may select the accumulation result 361 as its output to the activation circuit 330.

In response to the control signal CTRL being in the high logic state, the demultiplexer 350 may output the concatenated partial sum 352 as a whole to the multiplexer 340 as another input. At this time, since the control signal CTRL is in the high logic state, the multiplexer 340 may select the concatenated partial sum 352 as its output to the activation circuit 330.

The activation circuit 330 may perform activation operations (e.g., alone or with pooling, batch normalization, quantization, or a combination thereof) using the output from the multiplexer 340 to generate activation data 331. Thus, the router 320 may distribute the activation data from the activation circuit 330 to the respective activation buffer 383 in each sub PE array 380 for computation of the next layer in the convolutional neural network.

More specifically, since each sub PE array 380 has its own local processing elements 381, weight buffer 382, activation buffer 383, and accumulator 384, the architecture of the accelerator circuit 300 shown in FIG. 3 can have localized computation within each sub PE array. The activation data and weight are used by its own sub PE array.

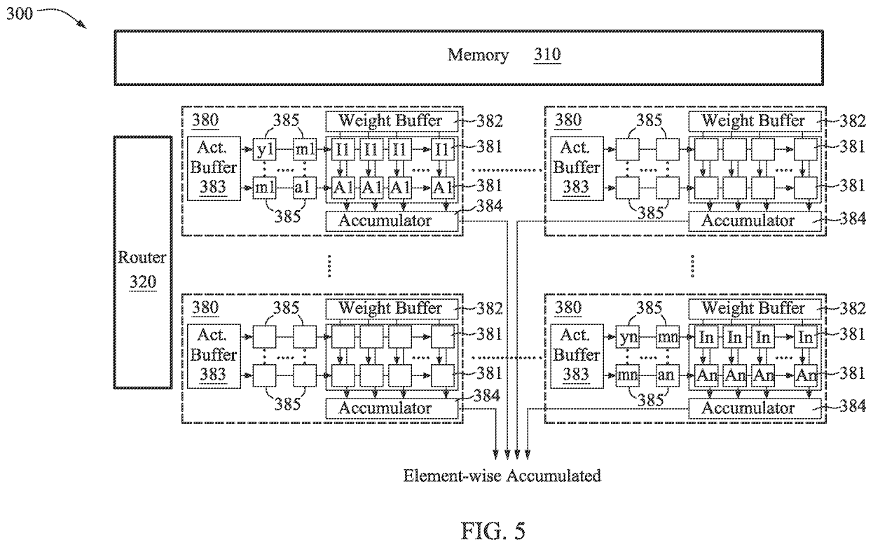

FIG. 5 is a diagram showing the weight-stationary data flow in the hardware circuit of the convolutional layer in accordance with the embodiment of FIG. 3. Please refer to FIGS. 2 to 5.

In an embodiment, the separated activation and weight pairs (e.g., in blocks 201 to 20N in FIG. 2) are assigned to different sub PE arrays 380. The sub PE arrays 380 may process the corresponding activation and weight pair in the same fashion such as the weight-stationary method or the activation-stationary method. For purposes of description, the weight-stationary data flow in the accelerator circuit 300 of the convolutional layer 200 is shown in FIG. 5.

For example, as shown in FIG. 5, the sub PE array 380 at the upper-left position in the accelerator circuit 300 may process the MAC operations and accumulation operations in block 201 shown in FIG. 2, and the sub PE array 380 at the bottom-right position in the accelerator circuit 300 may process the MAC operations and accumulation operations in block 20N in FIG. 2. In addition, other sub PE arrays 380 may process the MAC operations in their corresponding blocks in FIG. 2.

For example, given that a weight-stationary data flow is used, the weights are preloaded to each processing element 381 upon start of the standard convolution. Then, the input activations for each window (e.g., window 271) in activation array 251 are fetched from the activation buffer 383 to the leftmost column of processing element 381. Given that window 271 is shifted by a specific stride of 1 each time, there may be nine locations of window 271 on array 251, and nine combinations of elements are to be fetched from the activation buffer 383 to the leftmost column of the processing elements 381. The certain fetching rule is shown in registers 385, for example, the input activations from al to ml (i.e., the top-left window in array 251) will be fetched to the left-most column of the processing elements 381 at 1^{st} cycle, and the input activations from m1 to y1 (i.e., the bottom-right window in array 251) will be fetched to the left-most column of the processing elements 381 at 9^{th} cycle. During this process, the activation data at the left-most column of the processing elements 381 will be transferred to its neighboring columns of the processing elements 381 iteratively, till to the right-most column of the processing elements 381.

Similarly, there are also nine combinations of the corresponding window on each of arrays 252 to 25N, and nine combinations of elements to be fetched from the activation buffer 383 to the left-most columns of processing elements 381.

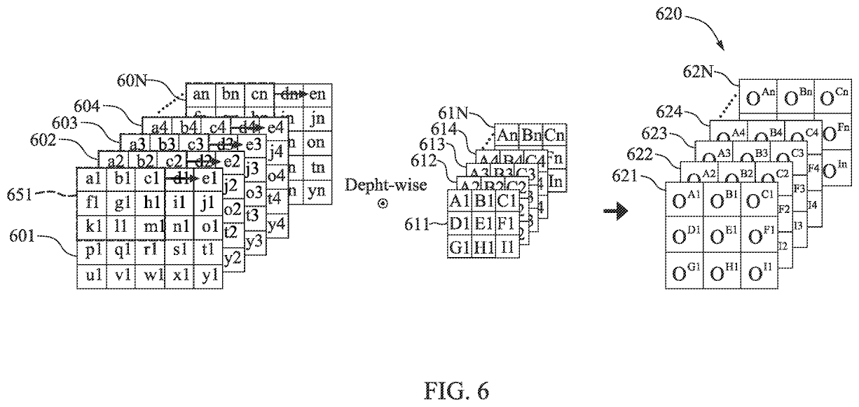

FIG. 6 is a diagram showing operations of a depth-wise convolution in a convolutional layer in accordance with an embodiment of the disclosure.

In an embodiment, a depth-wise convolution may refer to a type of convolution in which a single convolutional filter is applied for each input channel rather than for multiple input channels in the standard convolution. It should be noted that each of the arrays 601 to 60N can be regarded as the input activation of a corresponding channel, and each of the arrays 611 to 61N can be regarded as the weight (i.e., filter) of the corresponding channel. In the depth-wise convolution shown in FIG. 6, each of the arrays 601 to 60N is convolved with the respective array in the arrays 611 to 61N. For example, arrays 601 is convolved with array 611 to generate an output array 621, where window 651 is shifted by a specific stride (e.g., 1) on the array 601 each time to perform the MAC operation with the weight (e.g., array 611), and the MAC result can be put to the corresponding element O^{A1} in the output array 621. Other elements in the output array 621 can be calculated in a similar manner.

The convolutional operations for other channels can also be performed in a similar manner. The output array of the convolutional operations in each channel can be stacked to obtain the output (e.g., output cube 620 including output arrays 621 to 62N) of the depth-wise convolution.

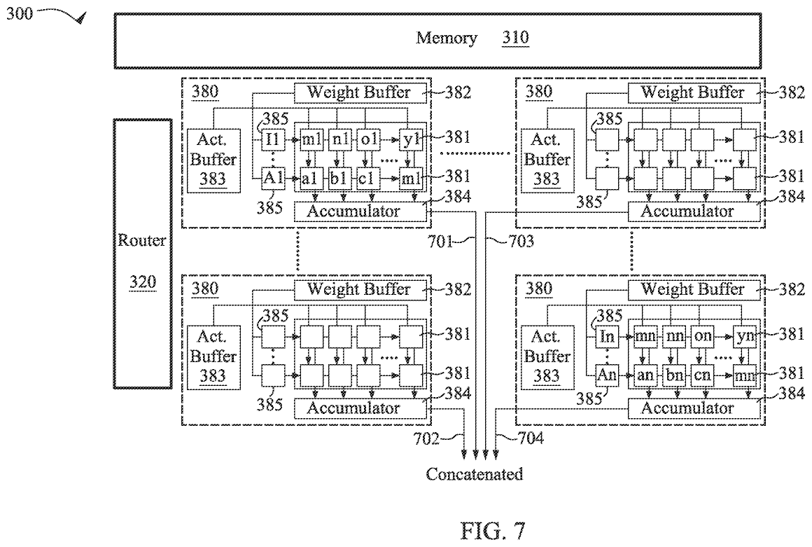

FIG. 7 is a diagram showing the input-stationary data flow in the hardware circuit of the convolutional layer in accordance with the embodiment of FIG. 6. Please refer to FIG. 3, FIG. 6, and FIG. 7.

In an embodiment, the activation and weight pairs in each channel are assigned to different sub PE arrays 380 of the accelerator circuit 300 while performing the depth-wise convolution. Each of the sub PE arrays 380 may process the activation and weight pair in the corresponding channel in the same fashion such as the weight-stationary method or the activation-stationary method. For purposes of description, the input-stationary data flow in the accelerator circuit 300 of the convolutional layer 200 that performs the depth-wise convolution is shown in FIG. 7. In the input-stationary (i.e., activation stationary) data flow, the input activations are loaded from the activation buffer 383 to each processing element 381 in each sub PE array 380 upon start of the depth-wise convolution. The processing elements 381 in the leftmost column may receive the input weight from the weight buffer 382, and these processing elements 381 may perform the MAC operation by multiplying the incoming weight by the preloaded activation, and adding the multiplication product to the incoming partial sum to generate an output partial sum. Then, these processing elements 381 pass the output partial sum to the processing elements 381 in the next row, and pass the weight to the processing elements 381 in the next column.

In other words, the output partial sums of the processing elements 381 in a given row, which is not the last row, are transmitted to the processing elements 381 in the next row. When the given row is the last row, the output partial sums calculated by the processing elements 381 in the given row are sent to the accumulator 384, and the accumulator 384 may accumulate the output partial sums from the processing elements 381 in the last row to generate a partial sum (e.g., partial sums 701 to 704) for the sub PE array 380. For purposes of description, there are four partial sums (e.g., partial sums 701 to 704) of the sub PE arrays 380 labeled on FIG. 7.

As depicted in FIG. 7, the sub PE array 380 at the upper-left position in the accelerator circuit 300 may process the MAC operations for the activation and weight pair in the first channel (e.g., arrays 601 and 611) shown in FIG. 6, and the sub PE array 380 at the bottom-right position in the accelerator circuit 300 may process the MAC operations for the activation and weight pair in the N-th channel (e.g., arrays 60N and 61N) in FIG. 6. In addition, other sub PE arrays 380 may process the MAC operations in their corresponding channels in FIG. 6.

For example, given that an input-stationary data flow is used, the activation data is preloaded to each processing element 381 upon start of the depth-wise convolution. Then, the weights for each window (e.g., window 651) in the arrays 611 to 61N of the weight cube are fetched from the weight buffer 382 to the left-most column of processing element 381.

More specifically, for the depth-wise convolution, since the processing elements 381 in each sub PE array 380 are dedicated for MAC operations of the corresponding channel, the accelerator circuit 300 can achieve high utilization of the processing elements 381 in each sub PE array 380.

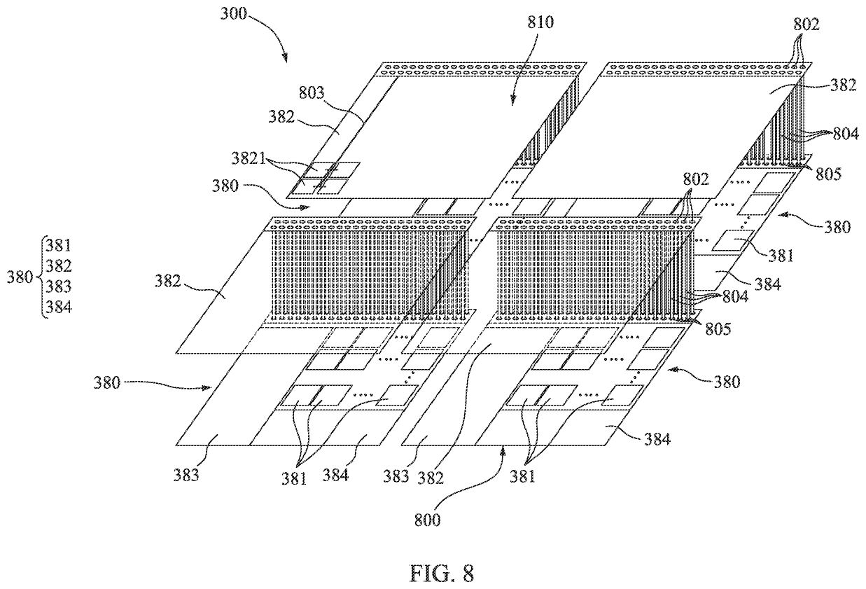

FIG. 8 is a diagram of a perspective view of the hardware circuit of the convolutional layer in accordance with the embodiment of FIG. 3. Please refer to FIG. 3 and FIG. 8.

In an embodiment, the accelerator circuit 300 may be implemented by a system-on-chip (SoC) or a system-in-package (SiP). The components other than the weight buffer 382 in each sub PE array 380 may be implemented on a die plane 800, and the weight buffer 382 in each sub PE array 380 may be implemented by another die plane 810. For example, the weight buffer 382 in each sub PE array 380 can be implemented by a three-dimensional-stacked (3D-stacked) DRAM over the die plane 800 of the sub PE arrays 380. In addition, the proposed structure can be implemented as 2D-IC as well, while 3D-IC could bring more benefits due to shorter interconnect. Also, the memory type is not limited by the design described in this disclosure.

As depicted in FIG. 8, the weight buffer 382 in each sub PE array 380 is in a top tier, and the input/output (I/O) bonds 802 of the weight buffer 382 connected to the I/O bonds 805 of the processing elements 381 in each sub PE array 380 through the TSVs (through-silicon via) 804. In other words, each sub PE array 380 has its own local TSV array (i.e., including the TSVs 804) that connects the weight buffer 382 to the processing elements 381 in each sub PE array 380. The length of the intra-buffer interconnect 803 (i.e., the distance between the I/O bonds 802 and the farthest memory cells 3821) is shorter in comparison with a global weight buffer for a monolithic PE array, and there is no need to distribute weight and activation data over larger global buffers and the global PE array. In addition, with the assistance of localized high-density SoIC (system of integrated circuits) bonds (e.g., I/O bonds 802 and 805), the accelerator circuit 300 can transfer the weight and activation data on a smaller scale so as to improve throughput and energy efficiency, thereby achieving fast and energy-efficient data-transfer of weight/activation data, and mitigating the use of larger buffer and long interconnects. Moreover, overall system performance can be improved across various workloads since the architecture shown in FIG. 7 and FIG. 8 can support both the standard convolution and depth-wise convolution with high utilization of the processing elements 381.

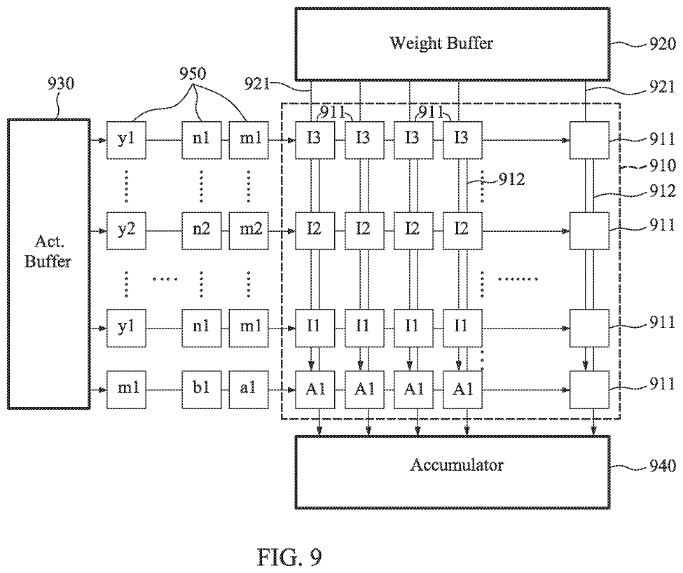

FIG. 9 shows the architecture of the hardware circuit of the convolutional layer in accordance with the embodiment of FIG. 1. Please refer to FIG. 1 and FIG. 9.

In an embodiment, the data flow of the standard convolution in FIG. 1 can be implemented using the accelerator circuit 900 in FIG. 9. The accelerator circuit 900 may include a PE array 910, a weight buffer 920, an activation buffer 930, an accumulator 940, and registers 950. The PE array 910 may include a plurality of processing elements 911 that are arranged in a two-dimensional systolic array. For example, given that a weight-stationary data flow is used, the weights are preloaded to each processing element 911 (e.g., through arrow 921) upon start of the standard convolution. Then, the input activations for each window (e.g., window 170) in the arrays 151 to 153 of the input activation cube 150 are fetched from the activation buffer 930 to the left-most column of the processing elements 911, following a certain rule as shown in the registers 950.

For example, given that window 170 is shifted by a specific stride of 1 each time, there may be nine locations of window 170 on array 151, and nine combinations of elements are to be fetched from the activation buffer 930 to the left-most column of the processing elements 911. Similarly, there are also nine combinations of the corresponding window on each of arrays 152 and 153, and nine combinations of elements to be fetched from the activation buffer 930 to the left-most column of the processing elements 911 for each of arrays 152 and 153.

Moreover, the weights in the weight cubes 110, 120, 130, and 140 are unrolled and preloaded into each processing element 911. For example, the weights in arrays 111, 112, and 113 of the weight cube 110 are unrolled and preloaded into the left-most column of processing elements 911 (e.g., weights A1 to I1 of array 111, weights A2 to I2 of array 112, and weights A3 to I3 of array 113). Similarly, the weights in arrays 121, 122, and 123 of the weight cube 120 are unrolled and preloaded into the second column of processing elements 911 (e.g., weights A1 to I1 of array 121, weights A2 to I2 of array 122, and weights A3 to I3 of array 123). The weights in arrays 131, 132, and 133 of the weight cube 130 are unrolled and preloaded into the third column of processing elements 911 (e.g., weights A1 to I1 of array 131, weights A2 to I2 of array 132, and weights A3 to I3 of array 133). The weights in arrays 141, 142, and 143 of the weight cube 140 are unrolled and preloaded into the fourth column of processing elements 911 (e.g., weights A1 to I1 of array 141, weights A2 to I2 of array 142, and weights A3 to I3 of array 143). If additional weight cubes are used, the weights in arrays of the additional weight cubes can be unrolled and preloaded into the subsequent column of processing elements 911.

In the accelerator circuit 900 shown in FIG. 9, the weight buffer 920 and the activation buffer 930 can be regarded as a global weight buffer and a global activation buffer, respectively. Thus, the weight buffer 920 and the activation buffer 930 may be much larger than the weight buffer 382 and activation 383 in each sub PE array 380 shown in FIG. 3, and it may indicate that weight and activation data are distributed over large buffers and the PE array 910. In other words, the accelerator circuit 300 shown in FIG. 3 can transfer the weight and activation data on a smaller scale so as to improve throughput and energy efficiency, thereby achieving fast and energy-efficient data-transfer of weight/activation data, and mitigating the use of larger buffer and long interconnects.

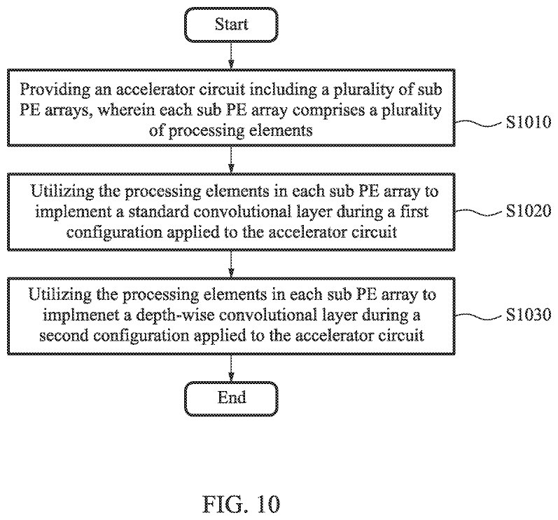

FIG. 10 is a diagram of a method for accelerating convolution in a convolutional neural network in accordance with an embodiment of the disclosure, the method including the following Steps. Please refer to FIG. 3 and FIG. 10.

Step 1010: providing an accelerator circuit comprising a plurality of sub processing-element (PE) arrays, wherein each sub PE array comprises a plurality of processing elements.

Step 1020: utilizing the processing elements in each sub PE array to implement a standard convolutional layer during a first configuration applied to the accelerator circuit.

Step 1030: utilizing the processing elements in each sub PE array to implement a depth-wise convolutional layer during a second configuration applied to the accelerator circuit.

For example, the first configuration and the second configuration may refer to the standard convolution and the depth-wise convolution, respectively. The control signal CTRL for the multiplexer 340 and demultiplexer 350 shown in FIG. 3 can be switched between the first configuration and the second configuration.

In an embodiment, the present disclosure provides an accelerator circuit for use in a convolutional layer of a convolutional neural network. The accelerator circuit includes a plurality of sub processing-element (PE) arrays, and each of the plurality of sub PE arrays comprises a plurality of processing elements. The processing elements in each of the plurality sub PE arrays implement a standard convolutional layer during a first configuration, and implement a depth-wise convolutional layer during a second configuration.

In another embodiment, the present disclosure provides a semiconductor device. The semiconductor devices includes plurality of sub processing-element (PE) arrays, and each sub PE array comprises a plurality of processing elements and a weight buffer. The processing elements in each sub PE array are implemented on a first die plane, and the weight buffer in each sub PE array is implemented on a second die plane that is on top of the first die plane. The processing elements (381) in each of the plurality sub PE arrays (380) implement a standard convolutional layer during a first configuration, and implement a depth-wise convolutional layer during a second configuration.

In yet another embodiment, the present disclosure provides a method for accelerating convolution in a convolutional neural network. The method includes the following steps: providing an accelerator circuit comprising a plurality of sub processing-element (PE) arrays, wherein each sub PE array comprises a plurality of processing elements; utilizing the processing elements in each sub PE array to implement a standard convolutional layer during a first configuration (S1020); and utilizing the processing elements in each sub PE array to implement a depth-wise convolutional layer during a second configuration.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope: processes, machines, manufacture, compositions of matter, means, methods or steps. In addition, each claim constitutes a separate embodiment, and the combination of various claims and embodiments are within the scope of the present disclosure.

What is claimed is:

1. An accelerator circuit for use in a convolutional layer of a convolutional neural network, comprising a plurality of sub processing-element (PE) arrays, wherein each of the plurality of sub PE arrays comprises a plurality of processing elements, wherein the processing elements in each of the plurality sub PE arrays implement a standard convolutional layer during a first configuration applied to the accelerator circuit, and implement a depth-wise convolutional layer during a second configuration applied to the accelerator circuit.

2. The accelerator circuit of claim 1, further comprising:
a memory, configured to store weights for the standard convolutional layer or the depth-wise convolutional layer in response to the first configuration or the second configuration being applied;
an activation circuit, configured to generate activation data for each sub PE array according to a first partial sum generated by each sub PE array;
a router, configured to distribute the activation data to each sub PE array;
a first accumulator;
a demultiplexer, configured to output the first partial sum generated by each sub PE array to the first accumulator to calculate an accumulation result in response to a control signal being in a low logic state, and to output a concatenated partial sum obtained from the first partial sum generated by each sub PE array in response to the control signal being in a high logic state; and
a multiplexer, configured to receive the accumulation result and the concatenated partial sum, and to respectively output the accumulation result and the concatenated partial sum to the activation circuit in response to the control signal being in the low logic state and the high logic state.

3. The accelerator circuit of claim 2, wherein in response to the first configuration being applied, the control signal is switched to the low logic state, wherein in response to the second configuration being applied, the control signal is switched to the high logic state.

4. The accelerator circuit of claim 2, wherein the activation circuit further comprises functions of pooling, batch normalization, quantization, or a combination thereof.

5. The accelerator circuit of claim 2, wherein the processing elements in each sub PE array are arranged in a two-dimensional systolic array, and each sub PE array further comprises:
an activation buffer, configured to store the distributed input activate data;
a weight buffer, configured to store the weight for the standard convolutional layer or the depth-wise convolutional layer; and
a second accumulator, configured to accumulate output partial sums from a bottom row of the processing elements of each sub PE array to generate the first partial sum of each sub PE array.

6. The accelerator circuit of claim 3, wherein the weights for the standard convolutional layer is preloaded into the processing elements in each sub PE array in response to the first configuration being applied, and the activation data for the depth-wise convolutional layer is preloaded into the processing elements in each sub PE array in response to the second configuration being applied.

7. The accelerator circuit of claim 6, wherein, for each sub PE array during the first configuration, when a specific row of the processing elements is not the bottom row, each processing element of the specific row receives an output partial sum from each processing element in a previous row of the processing elements, performs a multiply-accumulate operation by multiplying the activation data with the preloaded weight to generate a multiplication product, adds the multiplication product to the received output partial sum from each processing element in the previous row to generate the output partial sum of each processing element in the specific row, and transmits the output partial sum to each processing element in a next row.

8. The accelerator circuit of claim 6, wherein, for each sub PE array during the second configuration, when a specific row of the processing elements is not the bottom row, each processing element of the specific row receives an output partial sum from each processing element in a previous row of the processing elements, performs a multiply-accumulate operation by multiplying the weight with the preloaded activation data to generate a multiplication product, adds the multiplication product to the received output partial sum from each processing element in the previous row to generate the output partial sum of each processing element in the specific row, and transmits the output partial sum to each processing element in a next row.

9. The accelerator circuit of claim 5, wherein the activation buffer, the processing elements, and the second accumulator in each sub PE array are implemented on a first die plane, and the weight buffer in each sub PE array is implemented on a second die plane that is on top of the first die plane.

10. The accelerator circuit of claim 9, wherein the weight buffer communicates with the processing elements in each sub PE array through a local TSV (through-silicon via) array of each sub PE array.

11. A semiconductor device, comprising
a plurality of sub processing-element (PE) arrays,
wherein each sub PE array comprises a plurality of processing elements and a weight buffer, wherein the processing elements in each sub PE array are implemented on a first die plane, and the weight buffer in each sub PE array is implemented on a second die plane that is on top of the first die plane, and
wherein the processing elements in each of the plurality sub PE arrays implement a standard convolutional layer during a first configuration applied to the semiconductor device, and implement a depth-wise convolutional layer during a second configuration applied to the semiconductor device.

12. The semiconductor device of claim 11, further comprising:
a memory, configured to store weights for the standard convolutional layer or the depth-wise convolutional layer in response to the first configuration or the second configuration being applied;
an activation circuit, configured to generate activation data for each sub PE array according to a first partial sum generated by each sub PE array;
a router, configured to distribute the activation data to each sub PE array;
a first accumulator;
a demultiplexer, configured to output the first partial sum generated by each sub PE array to the first accumulator to calculate an accumulation result in response to a control signal being in a low logic state, and to output a concatenated partial sum obtained from the first partial sum generated by each sub PE array in response to the control signal being in a high logic state; and
a multiplexer, configured to receive the accumulation result and the concatenated partial sum, and to respectively output the accumulation result and the concatenated partial sum to the activation circuit in response to the control signal being in the low logic state and the high logic state,
wherein in response to the first configuration being applied, the control signal is switched to the low logic state,
wherein in response to the second configuration being applied, the control signal is switched to the high logic state.

13. The semiconductor device of claim 12, wherein the activation circuit further comprises functions of pooling, batch normalization, quantization, or a combination thereof

14. The semiconductor device of claim 12, wherein the processing elements in each sub PE array are arranged in a two-dimensional systolic array, and each sub PE array further comprises:
an activation buffer, configured to store the distributed input activate data;
a weight buffer, configured to store the weight for the standard convolutional layer or the depth-wise convolutional layer; and
a second accumulator, configured to accumulate output partial sums from a bottom row of the processing elements of each sub PE array to generate the first partial sum of each sub PE array.

15. The semiconductor device of claim 14, wherein the weights for the standard convolutional layer is preloaded into the processing elements in each sub PE array in response to the first configuration being applied, and the activation data for the depth-wise convolutional layer is preloaded into the processing elements in each sub PE array in response to the second configuration being applied.

16. The semiconductor device of claim 15, wherein, for each sub PE array during the first configuration, when a specific row of the processing elements is not the bottom row, each processing element of the specific row receives an output partial sum from each processing element in a previous row of the processing elements, performs a multiply-accumulate operation by multiplying the activation data with the preloaded weight to generate a multiplication product, adds the multiplication product to the received output partial sum from each processing element in the previous row to generate the output partial sum of each processing element in the specific row, and transmits the output partial sum to each processing element in a next row.

17. The semiconductor device of claim 15, wherein, for each sub PE array during the second configuration, when a specific row of the processing elements is not the bottom row, each processing element of the specific row receives an output partial sum from each processing element in a previous row of the processing elements, performs a multiply-accumulate operation by multiplying the weight with the preloaded activation data to generate a multiplication product, adds the multiplication product to the received output partial sum from each processing element in the previous row to generate the output partial sum of each processing element in the specific row, and transmits the output partial sum to each processing element in a next row.

18. The semiconductor device of claim 11, wherein the weight buffer communicates with the processing elements in each sub PE array through a local TSV (through-silicon via) array of each sub PE array.

19. A method for accelerating convolution in a convolutional neural network, the method comprising:
providing an accelerator circuit comprising a plurality of sub processing-element (PE) arrays, wherein each sub PE array comprises a plurality of processing elements;
utilizing the processing elements in each sub PE array to implement a standard convolutional layer during a first configuration applied to the accelerator circuit; and
utilizing the processing elements in each sub PE array to implement a depth-wise convolutional layer during a second configuration applied to the accelerator circuit.

20. The method of claim 19, wherein weights for the standard convolutional layer is preloaded into the processing elements in each sub PE array in response to the first configuration being applied, and activation data for the depth-wise convolutional layer is preloaded into the processing elements in each sub PE array in response to the second configuration being applied.
